(19) United States
(12) Patent Application Publication
(10) Pub. No.: US 2024/0193151 A1
(43) Pub. Date: Jun. 13, 2024

(54) OPTIMIZING PERFORMANCE OF COMPLEX TRANSACTIONS ACROSS DATABASES

(71) Applicant: INTERNATIONAL BUSINESS MACHINES CORPORATION, ARMONK, NY (US)

(72) Inventors: Yuan Gao, Beijing (CN); Xiao Min Zhao, Beijing (CN); Shuang Li, Beijing (CN); Hao Wu, Beijing (CN)

(21) Appl. No.: 18/062,842

(22) Filed: Dec. 7, 2022

(51) Int. Cl. G06F 16/23; G06F 16/2453

(52) U.S. Cl. CPC G06F 16/2379; G06F 16/24542

(57) ABSTRACT

Method, computer program product, and computer system are provided. A plurality of query activities are captured from one or more monitored databases. The query activities are persisted into a graph-enabled database repository. The plurality of query activities are classified into a plurality of workload rules based on there being a correlations between the plurality of query activities. A plurality of components of a total execution time of each query in a workload rule is analyzed. One or more problematic queries is identified based on the analyzing.

### BACKGROUND

The present invention relates to computer systems, and more specifically to database performing tuning.

Application transactions that access databases are becoming increasingly complex. Portions of the transactions can be distributed among multiple databases for execution. It is increasingly challenging for database administrators to monitor all the queries directed to the multiple databases, identify any bottleneck, and tune the queries to improve the overall performance. Current existing database monitor tools are only able to monitor and tune one database.

It would be advantageous to provide a database optimizer tool that can monitor the performance of all the databases that participate in a transaction, with a goal of identifying performance bottlenecks across the entire transaction that can be improved by tuning.

### SUMMARY

A method is provided. A plurality of query activities are captured from one or more monitored databases. The query activities are persisted into a graph-enabled database repository. The plurality of query activities are classified into a plurality of workload rules based on there being a correlations between the plurality of query activities. A plurality of components of a total execution time of each query in a workload rule is analyzed. One or more problematic queries is identified based on the analyzing.

Embodiments are further directed to computer systems and computer program products having substantially the same features as the above-described computer-implemented method.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates the operating environment of a computer server for executing unified monitoring, according to an embodiment of the present invention;

FIG. 2 illustrates an exemplary architecture of the unified monitoring system, in accordance with one or more aspects of the present invention;

FIG. 3 illustrates an exemplary process flow for executing the query to workload classification module, in accordance with one or more aspects of the present invention;

FIG. 4 illustrates an exemplary process flow for executing the workload bottleneck analysis module, in accordance with one or more aspects of the present invention; and

FIG. 5 illustrates an exemplary workload rule as expressed as a graph, in accordance with one or more aspects of the present invention.

### DETAILED DESCRIPTION

Applications that execute transactions using databases are becoming increasingly complex and may include multiple databases in the transaction. For example, a mobile APP checkout operation might comprise several REST APIs from multiple micro services, and at the underlying database level, there can be multiple transactions that invoke multiple SQL executions on multiple databases.

Monitoring performance in this complex environment becomes challenging. There may be multiple databases, and even multiple database vendors supporting portions of the application. However, in the current art, no integrated performance monitoring tool exists for performance tuning of complex transactions across multiple databases. Currently, each database management system (DBMS) provides its own dedicated monitoring utilities. However, as in the previous example, when multiple micro services require execution on multiple databases, there is no one tool/utility to holistically monitor and suggest performance tuning across the multi-DBMS environment. As used herein, “database” and “DBMS” is used interchangeably.

Embodiments of the present invention address the drawbacks currently existing in the art by providing a system and method for optimizing the performance of transactions that execute across multiple DBMSs. The present invention captures the query activities from a monitored DBMS and persists the records into a repository database. Query activities from transactions using multiple DBMSs are monitored using a timeseries algorithm, which provides the correlations of queries and identifies the query workload across DBMSs. In this context, a workload refers to the queries that always execute together. The present invention analyzes the total execution of each query in a workload and determines the bottleneck, if any. The analysis is performed using a breadth-first traversal of the workload, as created using the query activity records stored in a graph-enabled database. The output of the analysis includes recommendations for which query (or queries) should be tuned to improve the overall performance of the transaction.

As a further advantage, embodiments of the present invention accept as input query activity records from a heterogeneous mix of DBMS architectures and DBMS vendors. As used herein, “query” includes input/update/delete (IUD) operations, in addition to queries.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

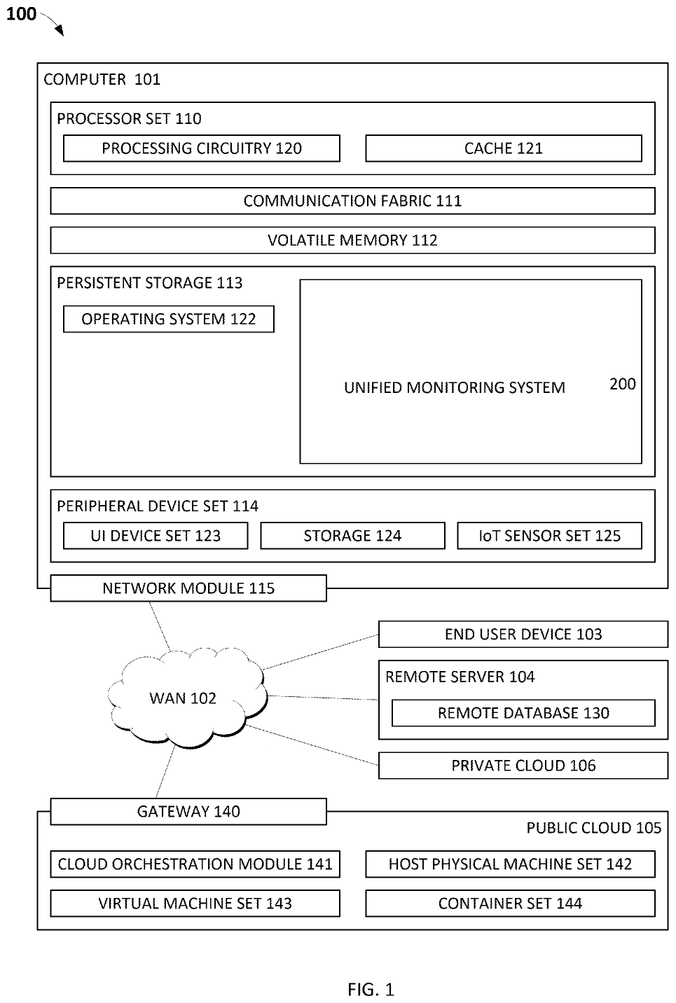

Beginning now with FIG. 1, an illustration is presented of the operating environment of a networked computer, according to an embodiment of the present invention.

Computing environment 100 contains an example of an environment for the execution of at least some of the computer code involved in performing the inventive methods, such as the unified monitoring system (system) 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, an administrator that operates computer 101), and may take any of the forms discussed above in connection with computer 101. For example, EUD 103 can be the external application by which an end user connects to the control node through WAN 102. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

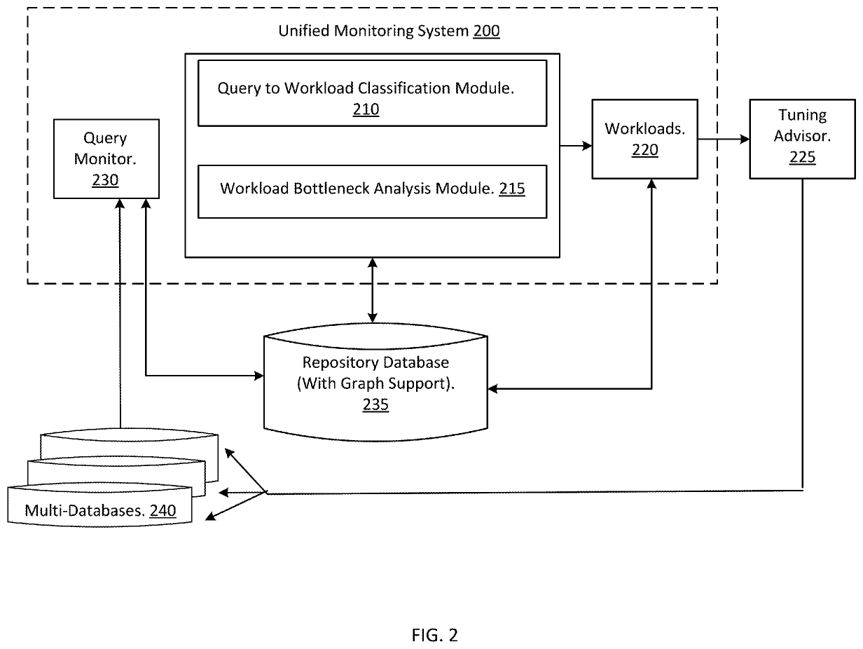

FIG. 2 illustrates an architecture for the unified monitoring system (system) 200.

The system 200 operates in a multi-database 240 environment. In this context, multi-database refers to at least one DBMS, one or more different DBMS architectures, or one or more different DBMS vendors.

A DBMS registers in the system 200 to allow the query monitor 230 access to the DBMS. The registration informs the query monitor 230 of the DBMS architecture and vendor, the format of the DBMS metric information, and the API (or interface) through which the query monitor 230 captures the metric information. This metric information is historical data for completed queries, therefore the currently executing queries are not interrupted. A time window during which to capture the metric information can be configured as a system 200 parameter. For example, for the test of a new function being added to the enterprise software, to capture the data during the test, the start and end times are configured. The query monitor 230 stores the captured metric information in a graph-enabled repository database 235. The following is an example format for a repository record and is based on metric information available in DB2® (DB2® is a registered trademark of IBM in the United States). Other formats are possible.

SQL Text: SELECT COL1, COL2, COL3 FROM TAB1, TAB2
WHERE...
START_TIME: 2022-04-01 12:01:02
END_TIME: 2022-04-01 12:01:04
APPL_ID: XXX_XXX
TOTAL_EXEC_TIME: 2021
TOTAL_WAIT_TIME: 1022
LOCK_WAIT_TIME: 778
ROWS_READ: 49302

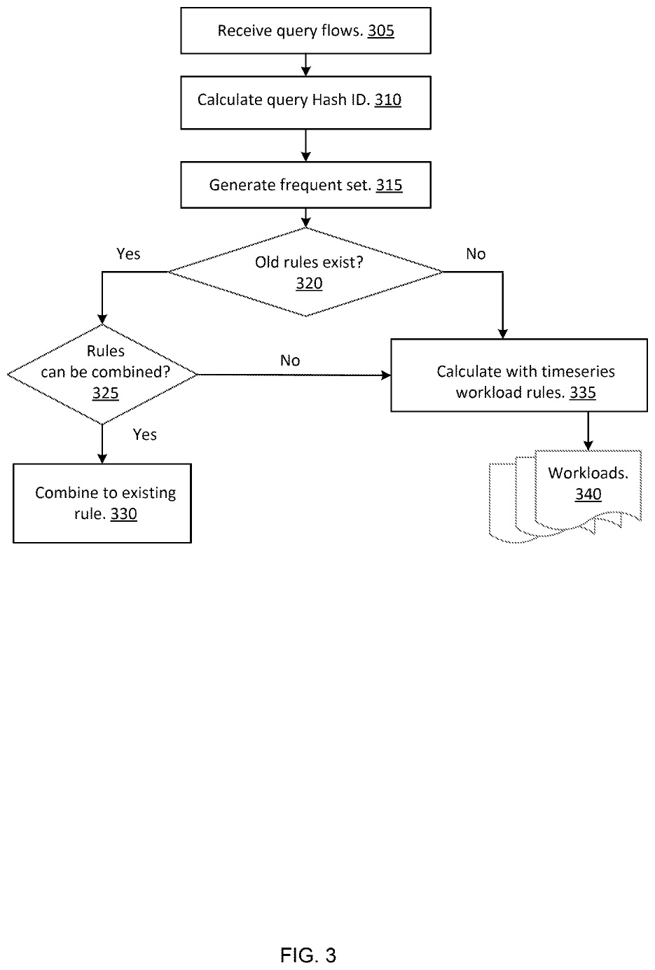

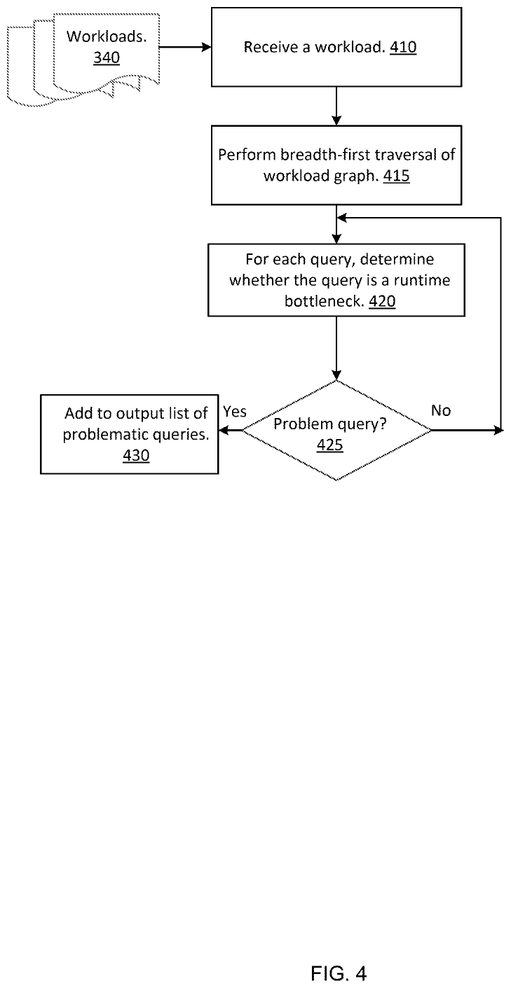

The system 200 includes the query to workload classification module (Q2WLM) 210 and the workload bottleneck analysis module (WLBAM) 215. As will be explained in FIG. 3, the Q2WLM 210 analyzes query activities on the multiple DBMS via a timeseries algorithm. The output of the Q2WLM 210 is a workload rule, which represents the correlation of the queries being executed in the business application. For example, an online banking application includes several operations to complete the transaction. Each operation may execute across multiple DBMS. In this context, a workload refers to at least two queries that execute together. The WLBAM 215 takes a workload as input and traverses the accompanying graph, as created using data from the graph-enabled repository database 235. The output of the graph traversal is one or more problematic queries for which performance tuning is recommended. The DBMS tuning advisor 225 of the DBMS on which the problematic query originally executed is notified of the problematic query. This is explained further with reference to FIG. 4.

Referring now to FIG. 3, an exemplary process flow for executing the Q2WLM 210 is provided.

At 305, the Q2WLM 210 retrieves query flow records from the graph-enabled repository database 235 for the requested time window.

At 310, for each retrieved query flow record the Q2WLM 210 calculates a unique hash ID based on the SQL text. The hash ID can be created using any one of a number of known algorithms. Since each SQL is a string of a variable length, the hash ID, being a uniform length, provides an efficient means to process the query flow records.

At 315, the Q2WLM 210 generates a frequent set using a timeseries algorithm. The generated frequent set is a pair of SQL queries that always occur together. Since it can happen, as in the online banking example, that the queries are from different DBMSs, the generated frequent set may include queries from more than one DBMS. The generated frequent set can become a workload rule following completion of the Q2WLM 210, for example, a generated frequent set is generated comprising Query C and Query A.

At 320, the Q2WLM 210 queries the graph-enabled repository database 235 for a workload rule matching the generated frequent set. The matching frequent set is one having both queries from the generated frequent set

At 325, the Q2WLM 210 determines whether the generated frequent set can be combined with the matching frequent set. A candidate for combining frequent sets is one where the matching frequent set includes more queries than the generated frequent set. However, if both the generated frequent set and the matching frequent set include the same queries, it would not be efficient to combine them. For example, assume two frequent set exist. Frequent set 1 comprises Query A, Query B, Query C and Query D. Frequent set 2 comprises Query B, Query C, and Query E. Frequent sets 1 and 2 can be combined as a frequent set 3, as they include Query B and Query C in common. Since the frequent set 3 also includes the generated frequent set comprising Query C and Query A, it is not efficient to create a new workload rule from the generated frequent set.

At 330, if a workload is found, the generated frequent set may be combined with the existing workload to create a new workload rule. Here, the generated frequent set comprising Query C and Query A is discarded because it would duplicate the frequent set 3 created in 325. Instead, a new workload rule is created from the frequent set 3, which is the combined frequent set 1 and frequent set 2.

However, if combining is not possible (325), for example, because an existing workload is not found having both of the queries in the generated frequent set, or if an old rule is not found (320) then (335) the timeseries algorithm is executed to create the generated frequent set in the graph-enabled repository database 235 as a workload rule. The timeseries association rules include rules to adjust the sequence of queries in the workload rule because the execution sequence of the queries is also considered in the timeseries association rules algorithm and will be used in 415 of FIG. 4 to generate the workload graph.

The workload rules 340 are stored in tables in the graph-enabled repository database 235 separately from the query flow records.

FIG. 4 illustrates an exemplary process flow for executing the workload bottleneck analysis module.

At 410 the WLBAM 215 retrieves a workload rule record 340 from the graph-enabled repository database 235. The workload rule record is represented in the form of a multi-nodal graph, with each node representing a query in the workload rule.

At 415, the WLBAM 215 performs a level-wise breadth-first traversal of the graph.

At 420, for each query (node of the graph) in the traversal of the graph, the WLBAM 215 determines whether that query is a runtime bottleneck by examining various metrics that are captured in the workload rule, including a total execution time of the query, any time spent in a wait condition, and the nature of the wait. For example, in the following hypothetical portion of the workload rule:

TOTAL_EXEC_TIME: 2021
TOTAL_WAIT_TIME: 1022
LOCK_WAIT_TIME: 778

It can be seen that approximately 50% of the execution time is spent in a wait condition. Of the wait time, approximately 76% is spent waiting on a lock. These performance metrics may flag this query for further examination by the DBMS tuning advisor 225. For example, thresholds can be configured for various performance metrics, such as wait time. The actual execution metrics of the query can be compared to historical performance metric values for the query.

At 425, if the WLBAM 215 determines that the query is a runtime bottleneck, the query is output to a list of problematic queries (430) for further investigation. The WLBAM 215 returns to 420 to examine the next node in the graph.

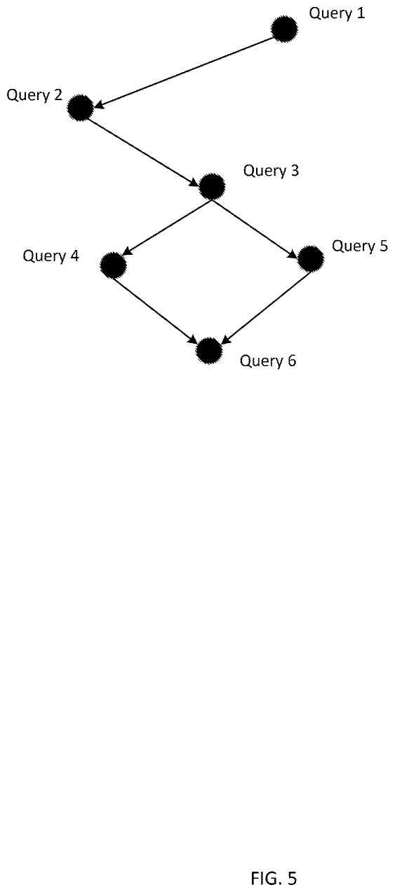

An example graph of a workload having six queries is shown in FIG. 5. Traversal begins at the root node, Query 1. As there are no neighboring nodes at the same level, traversal continues to Query 2 on the next level. Similarly, with no neighboring nodes on its level, traversal continues to Query 3, then to Query 3's neighbors, Query 4 and Query 5. Query 4's neighboring node Query 6 is next, followed finally by Query 5's neighboring node, Query 6.

1. A method, comprising:
performing timeseries analysis on historic metric information from completed queries according to a configurable time window, wherein the historic metric information is stored in each of one or more monitored databases;
classifying the analyzed timeseries historic metric information into a frequent set, wherein the frequent set is a correlation of at least two queries;
querying a graph-enabled repository database for a workload rule matching the frequent set;
based on a matching workload rule not being found, adding the frequent set as a node to the graph-enabled repository database as a new workload rule; and
performing a workload bottleneck analysis.

2. (canceled)

3. The method of claim 1, wherein the one or more monitored databases include a mix of different architectures and different vendors.

4. The method of claim 1, wherein the correlation is that at least two queries always execute together.

5. The method of claim 1, wherein the identifying further comprising:
forming the workload rule as a graph, wherein each node of the graph represents a query in the workload;
creating a ratio of each of the components to the total execution time;
comparing the created ratio to a configured threshold; and
determining the query is problematic based on at least one created ratio exceeding the configured threshold.

6. The method of claim 1, wherein the workload rule comprises at least two queries,
wherein the queries are correlated, and wherein the queries are directed to different databases, different database architectures, or databases from different vendors.

7. The method of claim 1, wherein a plurality of query activities is collected according to the configurable time window.

8. A computer program product, the computer program product comprising a non-transitory tangible storage device having program code embodied therewith, the program code executable by a processor of a computer to perform a method, the method comprising:
performing timeseries analysis on historic metric information from completed queries according to a configurable time window, wherein the historic metric information is stored in each of one or more monitored databases;
classifying the analyzed timeseries historic metric information into a frequent set, wherein the frequent set is a correlation of at least two queries;
querying a graph-enabled repository database for a workload rule matching the frequent set;
based on a matching workload rule not being found, adding the frequent set as a node to the graph-enabled repository database as a new workload rule; and
performing a workload bottleneck analysis.

9. (canceled)

10. The computer program product of claim 8, wherein the one or more monitored databases include a mix of different architectures and different vendors.

11. The computer program product of claim 8, wherein the correlation is that at least two queries always execute together.

12. The computer program product of claim 8, wherein the identifying further comprises:
forming the workload rule as a graph, wherein each node of the graph represents a query in the workload;
creating a ratio of each of the components to the total execution time;
comparing the created ratio to a configured threshold; and
determining the query is problematic based on at least one created ratio exceeding the configured threshold.

13. The computer program product of claim 8, wherein the workload rule comprises at least two queries, wherein the queries are correlated, and wherein the queries are directed to different databases, different database architectures, or databases from different vendors.

14. The computer program product of claim 8, wherein the plurality of query activities are collected according to the configurable time window.

15. A computer system, comprising:
one or more processors;
a memory coupled to at least one of the processors;
a set of computer program instructions stored in the memory and executed by at least one of the processors in order to perform actions of:
performing timeseries analysis on historic metric information from completed queries according to a configurable time window, wherein the historic metric information is stored in each of one or more monitored databases;
classifying the analyzed timeseries historic metric information into a frequent set, wherein the frequent set is a correlation of at least two queries;
querying a graph-enabled repository database for a workload rule matching the frequent set;
based on a matching workload rule not being found, adding the frequent set as a node to the graph-enabled repository database as a new workload rule; and
performing a workload bottleneck analysis.

16. (canceled)

17. The computer system of claim 15, wherein the one or more monitored databases include a mix of different architectures and different vendors.

18. The computer system of claim 15, wherein the correlation is that at least two queries always execute together.

19. The computer system of claim 15, wherein the identifying further comprises:
forming the workload rule as a graph, wherein each node of the graph represents a query in the workload;
creating a ratio of each of the components to the total execution time;
comparing the created ratio to a configured threshold; and
determining the query is problematic based on at least one created ratio exceeding the configured threshold.

20. The computer system of claim 15, wherein the workload rule comprises at least two queries, wherein the queries are correlated, and wherein the queries are directed to different databases, different database architectures, or databases from different vendors.

21. The method of claim 1, wherein performing the workload bottleneck analysis further comprises:
traversing the graph-enabled repository database level-wise and breadth-first;
for each node of the graph-enabled repository database, comparing metrics in the workload rule against configured performance metrics; and
outputting each workload rule having a metric outside a configurable performance metric for further analysis.

22. The computer system of claim 15, wherein performing the workload bottleneck analysis further comprises:
traversing the graph-enabled repository database level-wise and breadth-first;
for each node of the graph-enabled repository database, comparing metrics in the workload rule against configured performance metrics; and
outputting each workload rule having a metric outside a configurable performance metric for further analysis.

23. The computer program product of claim 8, wherein performing the workload bottleneck analysis further comprises:
traversing the graph-enabled repository database level-wise and breadth-first;
for each node of the graph-enabled repository database, comparing metrics in the workload rule against configured performance metrics; and
outputting each workload rule having a metric outside a configurable performance metric for further analysis.
